(19) United States
(12) Patent Application Publication
(10) Pub. No.: US 2025/0255220 A1
(43) Pub. Date: Aug. 14, 2025

(54) Roller Conditioner System

(71) Applicant: AGCO Corporation, Duluth, GA (US)

(72) Inventor: Donald Gilles, Hesston, KS (US)

(21) Appl. No.: 19/043,763

(22) Filed: Feb. 3, 2025

Related U.S. Application Data
(60) Provisional application No. 63/553,264, filed on Feb. 14, 2024.

(51) Int. Cl. A01D 82/02

(52) U.S. Cl. CPC A01D 82/02

(57) ABSTRACT

A roller conditioner system comprises a frame, one or more sets of conditioner rollers, each set comprising an upper conditioner roller and a lower conditioner roller separated by a roll gap through which cut crop may pass when processed by the roller conditioner system and a controller to control separation of the roll gap. Each end of each upper conditioner roller engages with and is supported by a conditioner roller support, each conditioner roller support providing a bearing for rotation of the upper conditioner roller. Each conditioner roller support is connected to a first end of a tension member. To each end of each upper conditioner roller, the roller conditioner system further comprises a conditioner roller adjustment mechanism actuated by the controller to adjust the roll gap. Each conditioner roller adjustment mechanism comprises a framework secured to the frame of the roller conditioner system, an actuator secured to the framework of the conditioner roller adjustment mechanism, and a displaceable locating element connected at a first end to the actuator and adapted for movement with respect to the framework, the displaceable locating element supporting a first end of the tension member.

### CROSS-REFERENCE TO RELATED APPLICATIONS

This application claims the benefit of the filing date of U.S. Provisional Patent Application 63/553,264, “Roller Conditioner System,” filed Feb. 14, 2024, the entire disclosure of which is incorporated herein by reference.

### FIELD

The present invention relates to crop harvesting apparatus of the type that use rotary cutters to sever standing crops from the field and then condition the cut crop between one or more sets of upper and lower conditioning rollers before depositing the cut crop back onto the field in the form of a windrow or a swath and more particularly, it relates to a roller conditioner system for such crop harvesting apparatus and to a roller adjustment mechanism to adjust the roll gap separating the upper and lower conditioner rollers.

### BACKGROUND

Roller conditioner systems are commonly integrated into mower-conditioners to mechanically process or “condition” certain crops, such as alfalfa and other forage crops, for field wilting and drying. In contrast to impeller conditioner systems, roller conditioner systems contain one or more sets of upper and lower conditioner rollers. The conditioner rollers are separated by an adjustable “roll gap”.

Proper conditioning is a balance between optimising the desired crop quality (in order to sell the cut crop for the best economic return), throughput of the cut crop through the roller conditioner systems and the rate of crop ‘dry down’ (that is the rate at which the cut crop will lose moisture on the field before it is next processed, for example when baling occurs).

Historically, it has been left to an operator to determine this balance, for example by setting the roll gap prior to commencing operation in a field based upon prior knowledge and experience and then using this setting for the entire field without reference to changing operating environments within different regions of the field.

A number of electronic control systems for controlling the roll gap have been proposed, for example in EP 4 032 390 A1 (Deere & Company).

It is an advantage of the present invention that an improved conditioner roller adjustment mechanism is provided.

### BRIEF SUMMARY

According to a first aspect of the present invention, a roller conditioner system comprises a frame, one or more sets of conditioner rollers, each set comprising an upper conditioner roller and a lower conditioner roller separated by a roll gap through which cut crop may pass when processed by the roller conditioner system, each end of each upper conditioner roller engaging with and being supported by a conditioner roller support, each conditioner roller support providing a bearing for rotation of the upper conditioner roller, each conditioner roller support being connected to a first end of a tension member, the roller conditioner system further comprising a controller and to each end of each upper conditioner roller a conditioner roller adjustment mechanism actuated by the controller to adjust the roll gap separating each of the upper and lower conditioner rollers, each conditioner roller adjustment mechanism further comprising:
a framework secured to the frame of the roller conditioner system,
an actuator secured to the framework of the conditioner roller adjustment mechanism, and
a displaceable locating element connected at a first end to the actuator and adapted for movement with respect to the framework, the displaceable locating element supporting a first end of the tension member.

Preferably, the displaceable locating element comprises a base plate and first and second upstanding side walls provided with parallel upper surfaces supporting the first end of the tension member, the parallel upper surfaces of the side walls including a portion arranged inclined to the base plate such that movement of the displaceable locating element with respect to the framework causes a second end of the tension member to be displaced with respect to the framework.

Preferably, each conditioner roller adjustment mechanism further comprises a layer of low friction material located between the framework of the conditioner roller adjustment mechanism and a lower surface of the displaceable locating element, more preferably a lower surface of the base of the displaceable locating element.

More preferably, the layer of low friction material is provided with an elongate opening.

More preferably, the low friction material is an ultra-high molecular weight polyethylene.

Preferably, each actuator is a linear actuator.

Preferably, the base plate of the displaceable locating element is provided with an elongate opening extending between the first and second upstanding side walls.

### BRIEF DESCRIPTION OF THE DRAWINGS

The invention will now be described, by way of example only, with reference to the accompanying drawings, in which:

FIG. 1 shows a harvesting apparatus having a roller conditioner system;

FIG. 2 shows a perspective view of elements of the roller conditioner system;

FIG. 3 shows an end view of the elements of the roller conditioner system of FIG. 2;

FIG. 4 shows a first side perspective view of certain elements of the roller adjustment mechanism;

FIG. 5 shows a second opposite perspective side view of certain elements of the roller adjustment mechanism;

FIG. 6 shows a first perspective view of certain elements of the roller adjustment mechanism;

FIG. 7 shows in schematic form elements of a control system for operation of the controller;

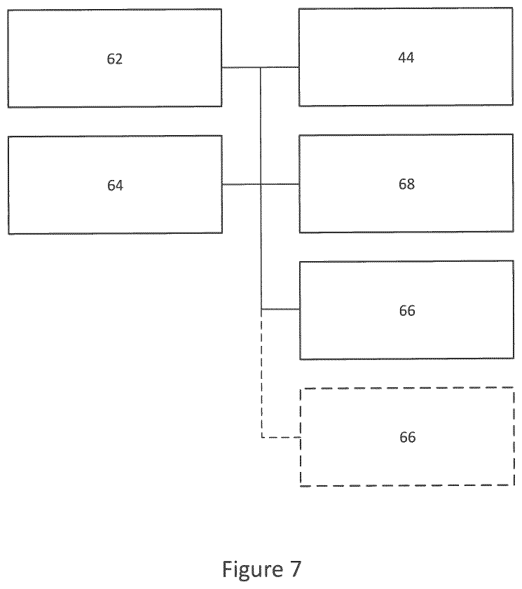

FIG. 8 shows a further perspective view of certain elements of the roller adjustment mechanism.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Relative terms such as forward, rearward, transverse, lateral, longitudinal and sideways will be made with reference to the normal forward direction of travel of the harvesting apparatus. The terms vertical and horizontal will be made with reference to level ground upon which the harvesting apparatus is disposed. The terms “upstream” and “downstream” are made with reference to the general direction of crop flow along the material conveyance systems described.

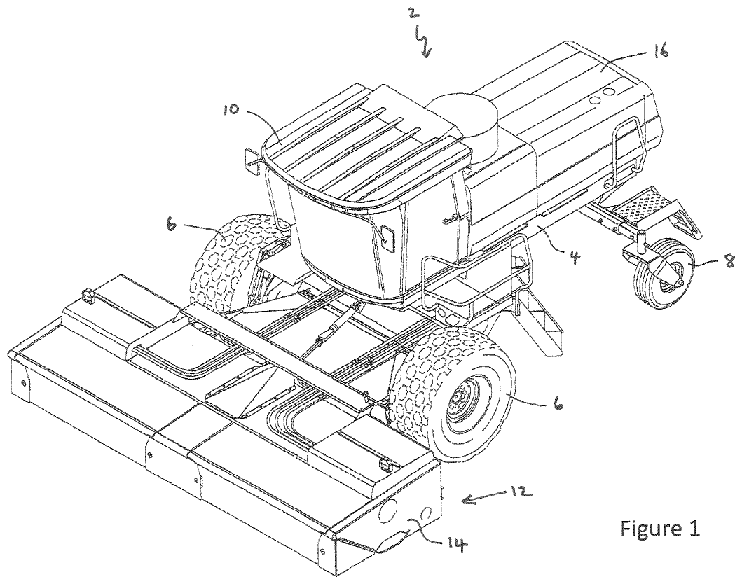

Referring first to FIG. 1, the illustrated harvesting apparatus 2 is a self-propelled windrower operable to cut standing crop in the field, to condition the cut material as it moves through a roller conditioner system to improve its drying characteristics, and then to return the conditioned cut crop to the field in a windrow or swath. The windrower includes a chassis or frame 4 supported by a pair of front drive wheels 6 and a pair of rear caster wheels 8 (only the left rear caster wheel being visible in FIG. 1) for movement across a field to be harvested. The frame carries a cab 10, within which an operator directs operation of the windrower, and a rearwardly spaced compartment 16 that houses a power source (not shown) such as an internal combustion engine. A harvesting header 12 is supported on the front of the frame 4 in a manner well understood by those skilled in the art.

The harvesting header 12 comprises a header frame 14 within which a rotary cutter bed (not shown) and a set of centrally disposed conditioner rollers are mounted. The rotary cutter bed extends across the front of the harvesting apparatus 2 and serves as the means by which standing crops are severed as the harvesting apparatus 2 advances across a field. The set of centrally disposed conditioner rollers are located behind the cutter bed. In the illustrated example, two pairs of cooperating conditioner rollers are shown, although alternatively, a single pair of rollers or more than two pairs of rollers could be used. The construction of such conditioner rollers is well understood by those skilled in the art.

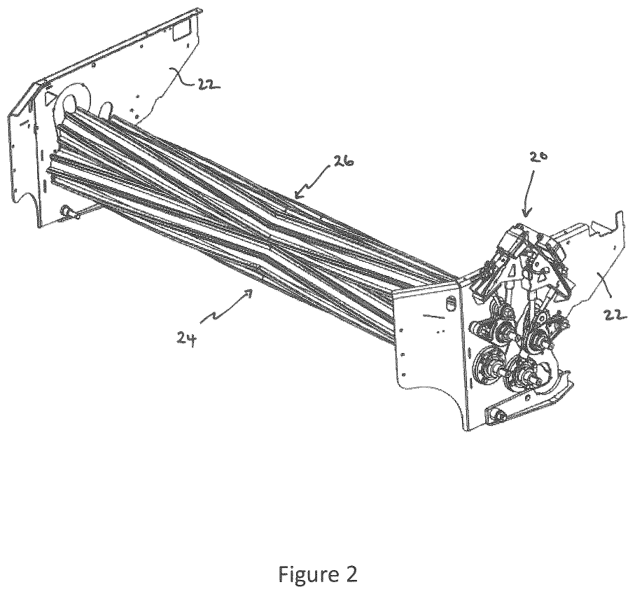

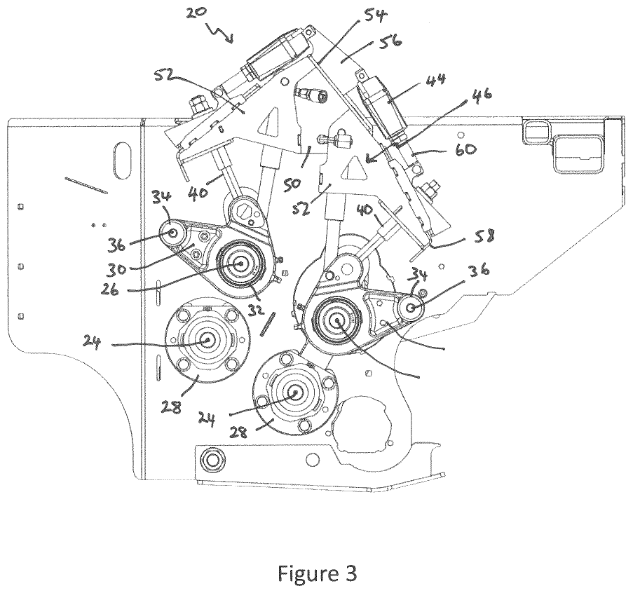

FIG. 2 illustrates a roller conditioner system 18 located within the header 12 together with at each end, conditioner roller adjustment mechanisms 20 (shown in more detail in FIGS. 3 to 6 and 8).

In practice, the structures at the right-hand side of the roller conditioning system 18 are mirrored on the left-hand side about a central plane of the roller conditioning system 18 (those on the right hand side of FIG. 2 having been omitted for clarity). As such, as context permits, only one side of the roller conditioning system 18 will be described.

As may best be seen in FIGS. 2 and 3, the structures around each of the first and second sets of conditioner rollers correspond. As such, as context permits, the structures relating to a single set of conditioner rollers will be described.

In the illustrated example, it can be seen that the conditioner rollers are mounted between first and second end panels 22. The first and second end panels 22 are themselves mounted within the header frame 14.

Lower conditioner rollers 24 are each mounted for rotation about a fixed axis in bearing housings 28 provided within the first and second end panels 22. Upper conditioner rollers 26 are suspended in and between upper conditioner roller supports 30 above the lower conditioner rollers 24 such that the axis of rotation of each of the upper conditioner rollers 26—and so the roll gap between the working surfaces of the lower conditioner rollers 26 and the upper conditioner rollers 28—can be adjusted.

Each of the upper conditioner roller supports 30 provides a bearing housing 32 in which the ends of each upper conditioner roller 26 may rotated, a second bearing 34 through which a pivot pin 36 extends to allow angular movement of the upper conditioner roller support 30 about an axis defined by the pivot pin 36, and a mounting point for a second end of a tension member 40, the tension member 40 forming part of a conditioner roller adjustment mechanism 20.

The pivot pin 36 is mounted to the adjacent end panel 22 in a suitable manner.

Two conditioner roller adjustment mechanisms 20 are shown in FIGS. 3, 4 and 5. It will be understood that a similar arrangement is provided at the other side of the roller conditioner system 18. In the interests of clarity, elements of the roller conditioning system 18 have also been omitted from some of the figures.

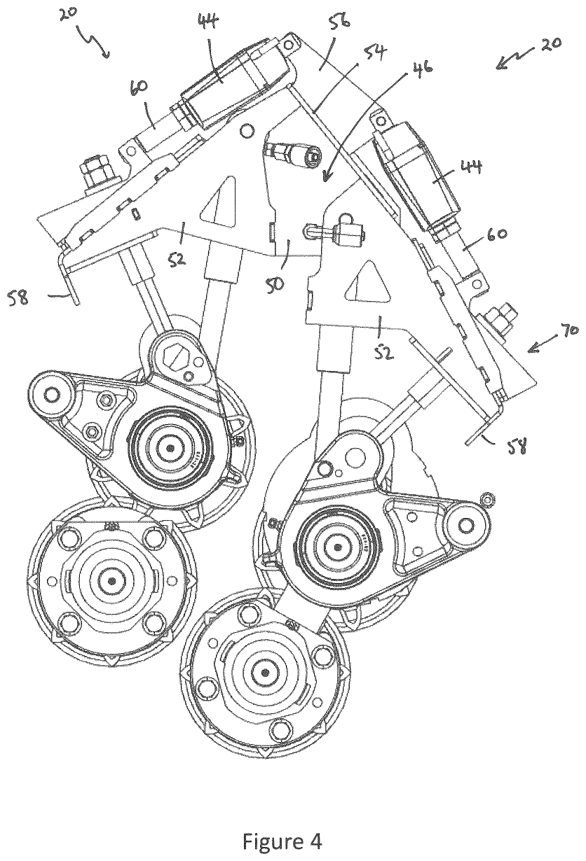

Elements of the conditioner roller adjustment mechanism 20 are best seen in FIGS. 4 to 6 and 8.

An actuator 44 forming a part of the conditioner roller adjustment mechanism 20 is mounted to an upper part of a framework 46 provided on the end panel 22 as described below. The framework 46 may be secured to the associated end panel 22 in any suitable manner for example by fastenings or by welding.

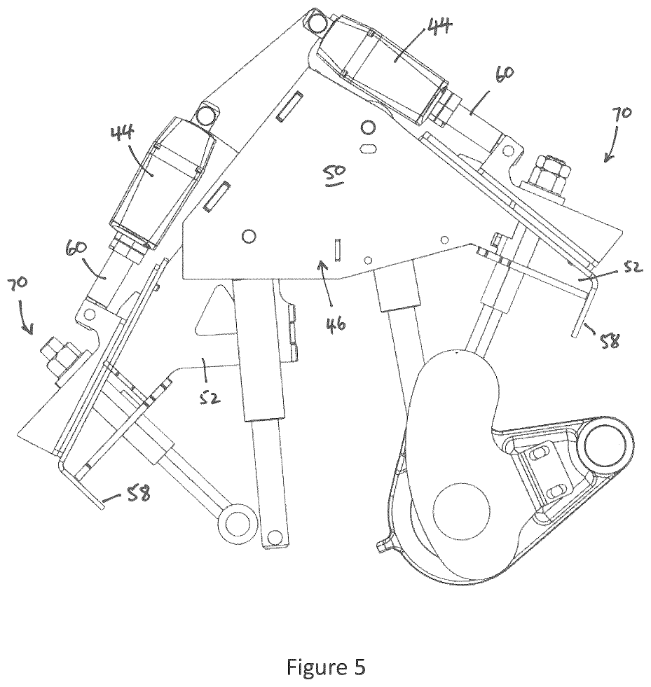

In the illustrated embodiment, the framework 46 comprises a rear panel 50 (seen most clearly in FIG. 5 where the end plate 22 has been omitted for clarity) and front panels 52 associated with each conditioner roller adjustment mechanism 20 (FIGS. 3 and 4). Each of the front panels 52 are secured to the rear panel 50 by way of a connecting web 54. The connecting web 54, the rear panel 50 and the front panels 52 may be secured together in any suitable manner, for example by welding. The connecting web 54 is provided with a central upright flange 56. The central upright flange 56 may be secured to the connecting web 54 in any suitable manner, for example by welding. Each front panel 52 is further provided with a further connecting web 58 (FIG. 5). The front panels 52 and the further connecting webs 58 may be secured together in any suitable manner, for example by welding.

The actuator 44 may be secured in place in any convenient manner. In the illustrated embodiment the actuator 44 can be seen to include an armature 60. In the illustrated embodiment a first end of the actuator 44 is secured to the central upright flange 56, and a free end of the armature 60 is connected to a displaceable locating element 70.

The actuator 44 is in electrical communication with a controller or electronic control unit 62 over a suitable network. The electronic control unit 62 may be located on the harvesting apparatus 2 (as in the case of a self-propelled windrower) or on either a towing vehicle or the harvesting apparatus (in the case of a towed harvesting apparatus). The electronic control unit 62 is provided with a memory unit 64 and is in electrical communication with a variety of sensors 66. The electronic control unit 62 is operative to receive signals from the sensors 66, process these signals in accordance with instructions provided in the memory unit 64 and issue control signals to the actuator 44 in accordance with those instructions. Additionally, or alternatively, the electronic control unit 62 is operative to receive operator instructions input into a suitable machine user interface such as a touchscreen of a user terminal 68 as user terminal signals, process these signals in accordance with instructions provided in the memory unit 64 and issue control signals to the actuator 44 in accordance with those instructions.

Conveniently the actuator 44 is a linear actuator, for example a mechanical, electro-mechanical, hydraulic or pneumatic actuator.

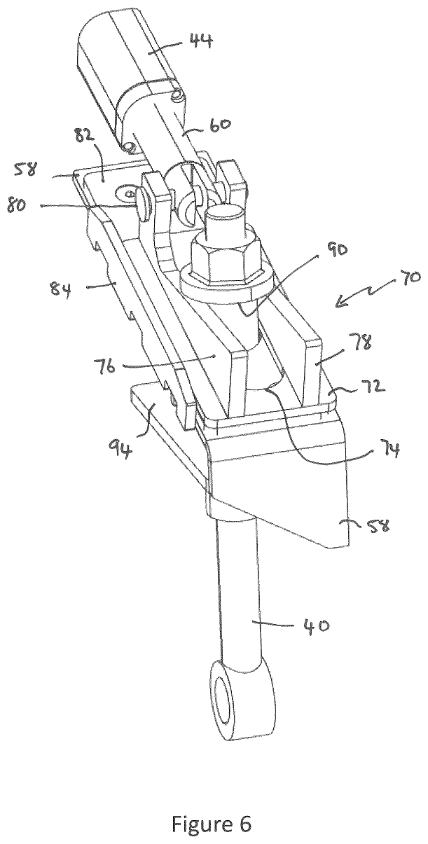

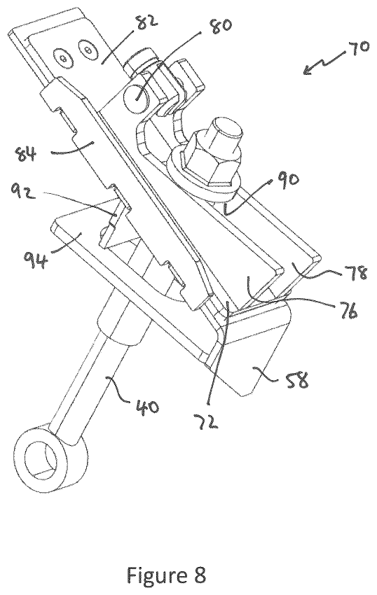

As may be best seen in FIGS. 6 and 8, the displaceable locating element 70 comprises a base plate 72 having an elongate opening 74 disposed along a central axis. To each side of the elongate opening 74 first and second upstanding side walls 76,78 are provided orthogonally to the base plate 72. The base plate 72 and the first and second side walls 76,78 may be secured together in any suitable manner, for example by welding.

Each of the first and second side walls 76,78 comprises a first upright portion connected to a second generally triangular portion such that an upper edge of the triangular portion extends downwardly toward a lower portion of the upright portion to create a valley between each end of the side walls 76,78. In this way, a portion of the upper edges of the first and second side walls 76,78 can be seen to provide a support surface inclined to the base plate 72. Openings are provided in the free end of each upright portion. In use a pivot pin 80 extends though the upright portions and the free end of the actuator armature 60 to secure the actuator armature 60 to the displaceable locating element 70. The pivot pin 80 may be provided with grooves within which circlips may be located to retain the actuator armature 60 and the displaceable locating element 70 in axial position along the pivot pin 80.

The base plate 72 of the displaceable locating element 70 is seated on a layer of low friction material 82 provided on the associated further connecting web 58. The layer of low friction material 82 may be affixed to the associated further connecting web 58 in any suitable manner. An example of a suitable low friction material includes an ultra-high molecular weight polyethylene. The layer of low friction material 82 is also provided with an elongate opening extending along its lengthwise axis.

The displaceable locating element 70 is constrained for movement on the one side by the side plate 22 to which the framework 46 is secured and an outer side wall 84. The outer side wall 84 comprises a shaped plate located in position by a plurality of tabs on the associated further connecting web 58 seating within corresponding recesses on the outer side wall 84. The outer side wall 84 is secured to the associated further connecting web 58 in any suitable manner, for example by welding.

The tension member 40 extends though the elongate opening 82 of the displaceable locating element 70 as well as the elongate opening of the layer of low friction material 82. A second end of the tension member 40 is provided with an abutment surface 90, for example a surface of a washer or nut provided on the tension member 40, such that the abutment surface 90 of the tension member 40 rests on the upper surfaces of the first and second side walls 76,78 of the displaceable locating element 68, that is the support surface inclined to the base plate 72.

The upper portion of the tension member 40 is threaded so that the abutment surface 90 provided by the washer or nut can be manually threaded up and down the tension member 40. This allows manual adjustment of the roller gap, so that in the case where an operator may want to adjust the conditioner roller 26 to provide a separation greater than the displaceable locating element 70 can provide on its own, the separation of the roller conditioner rollers 24,26 can still be manually adjusted by way of the threaded element 90 (by adjusting the effective length of the tension member 40), and then additionally adjusted by operation of the conditioner roller adjustment mechanism. For example, an operator may be cutting a crop for which the operator wishes to minimize the conditioning intensity for fear of damaging the crop. By way of example, on a double conditioner header arrangement (with first and second sets of upper and lower conditioner rollers) the operator may have a first, front conditioner roller pair set “closed” to condition the crop, but the operator may manually adjust the second, rear conditioner roller pair set “wide open” so that this roller conditioner roller pair is effectively no longer conditioning the crop.

In the illustrated embodiment the framework 46 further includes a reinforcing element 92 and an additional side plate 94, the reinforcing element 92 extending between the further connecting web 58 and the side plate 94 (FIG. 8). The additional side plate 94 is also provided with an elongate opening though which the tension member 40 in use extends (FIG. 8). In use the reinforcing plate 92 and the additional side plate 94 are located with respect to the side panel 22 and secured thereto in any suitable manner, for example by welding.

In the illustrated example the roll gap is at its narrowest setting with the upper conditioner roller at its closest position to the lower conditioner roller. On receipt of a suitable signal from the electronic control unit 48, the actuator 44 is operated to draw the displaceable locating element 70 toward the actuator 40. As a result, the displaceable locating element 70 passes under the abutment surface 90 of the tension member 40 causing the second end of the tension member 40 to ride up the inclined surfaces presented by the upper surfaces of the side walls 76,78 of the displaceable locating element 70 and so raise the tension member 40 relative to the illustrated position. This in turn will cause the upper conditioner roller support 30 to which the first end of the tension member 40 is connected to be rotated about the pivot pin 36 so raising the end of the upper conditioner roller 26 and so increasing the roll gap.

It will be appreciated that by sending like signals to each of the actuators (that is the actuators to the left- and right-hand side of each the upper conditioner roller 26) an even separation of the roll gap across the width of a conditioner roller pair can be maintained.

The side plate 94 also serves to limit the travel of the roller support 30 about the pivot pin 36 in the case where the upper and lower conditioner rollers 26,24 are as far apart or as “open” as they can go. For example, if a large mass of crop instantaneously flows through the roller conditioner system, the tension force on the tension member 40 will be overcome and the conditioner rollers 24,24 will part, due to the lifting of the upper conditioner roller 26, until the roller support 30 makes contact with the side plate 94. After the mass of crop has passed through the roller conditioner system, the tension force restores the upper conditioner roller 26 to the set “down” position.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of square harvesting apparatus and component parts therefore and which may be used instead of or in addition to features already described herein.

What is claimed is:

1. A roller conditioner system comprises a frame, one or more sets of conditioner rollers, each set comprising an upper conditioner roller and a lower conditioner roller separated by a roll gap through which cut crop may pass when processed by the roller conditioner system, each end of each upper conditioner roller engaging with and being supported by a conditioner roller support, each conditioner roller support providing a bearing for rotation of the upper conditioner roller, each conditioner roller support being connected to a first end of a tension member, wherein to each end of each upper conditioner roller, the roller conditioner system further comprising a controller and to each end of each upper conditioner roller a conditioner roller adjustment mechanism actuated by the controller to adjust the roll gap separating each of the upper and lower conditioner rollers, each conditioner roller adjustment mechanism further comprising
a framework secured to the frame of the roller conditioner system,
an actuator secured to the framework of the conditioner roller adjustment mechanism, and
a displaceable locating element connected at a first end to the actuator and adapted for movement with respect to the framework, the displaceable locating element supporting a first end of the tension member.

2. A roller conditioner system according to claim 1, wherein in each conditioner roller adjustment mechanism the displaceable locating element comprises a base plate and first and second upstanding first and second upstanding side walls provided with parallel upper surfaces supporting the first end of the tension member, the parallel upper surfaces of the side walls including a portion arranged inclined to the base plate such that movement of the displaceable locating element with respect to the framework causes a second end of the tension member to be displaced with respect to the framework.

3. A roller conditioner system according to claim 1, wherein each conditioner roller adjustment mechanism further comprises a layer of low friction material located between the framework of the conditioner roller conditioner system and a lower surface of the displaceable locating element.

4. A roller conditioner system according to claim 3, wherein the layer of low friction material located between the framework of the conditioner roller conditioner system and a lower surface of the base plate of the displaceable locating element.

5. A roller conditioner system according to claim 4, wherein in each conditioner roller adjustment mechanism the layer of low friction material is provided with an elongate opening.

6. A roller conditioner system according to claim 4, wherein the low friction material is an ultra-high molecular weight polyethylene.

7. A roller conditioner system according to claim 1, wherein in each conditioner roller adjustment mechanism each actuator is a linear actuator.

8. A roller conditioner system according to claim 2, wherein in each conditioner roller adjustment mechanism the base plate of the displaceable locating element is provided with an elongate opening extending between the first and second triangular side walls.
